(19) United States
(12) Patent Application Publication
(10) Pub. No.: US 2010/0190076 A1
(43) Pub. Date: Jul. 29, 2010

(54) TWO STAGE, HFR-FREE FREEZE PREPARATION SHUTDOWN STRATEGY

(75) Inventors: JOHN C. FAGLEY, Victor, NY (US); Steven R. Falta, Honeoye Falls, NY (US)

Correspondence Address: MILLER IP GROUP, PLC;GENERAL MOTORS CORPORATION, 42690 WOODWARD AVENUE, SUITE 200, BLOOMFIELD HILLS, MI, 48304, US

(73) Assignee: GM GLOBAL TECHNOLOGY OPERATIONS, INC., DETROIT, MI (US)

(21) Appl. No.: 12/358,989

(22) Filed: Jan. 23, 2009

(51) Int. Cl. H01M 8/04

(52) U.S. Cl. 429/439; 429/450; 429/456

(57) ABSTRACT

A system and method for providing a fuel cell stack purge at fuel cell system shut-down. The method provides a two-stage purge process where the first stage purge uses humidified cathode air to get the fuel cell stack to a known stack hydration level from an unknown stack hydration level at system shut-down. As the stack is purged with the humidified air, the hydration level of the stack decreases asymptotically to the known stack hydration level where the duration of the first stage is set based on the asymptote as a safety margin. Once the known hydration level is achieved, then the second stage purge is performed with dry air to further reduce the stack hydration to a final desired hydration level.

### BACKGROUND OF THE INVENTION

1. Field of the Invention

This invention relates generally to a method for purging a fuel cell stack at system shut-down and, more particularly, to a method for purging a fuel cell stack at system shut-down using a two stage process where the first stage includes purging the stack with humidified cathode air having a known relative humidity to get the stack to a known hydration level and the second stage includes purging the stack with dry cathode air to reduce the stack hydration level from the known hydration level to a desired final hydration level.

2. Discussion of the Related Art

Hydrogen is a very attractive fuel because it is clean and can be used to efficiently produce electricity in a fuel cell. A hydrogen fuel cell is an electrochemical device that includes an anode and a cathode with an electrolyte therebetween. The anode receives hydrogen gas and the cathode receives oxygen or air. The hydrogen gas is dissociated in the anode to generate free protons and electrons. The protons pass through the electrolyte to the cathode. The protons react with the oxygen and the electrons in the cathode to generate water. The electrons from the anode cannot pass through the electrolyte, and thus are directed through a load to perform work before being sent to the cathode.

Proton exchange membrane fuel cells (PEMFC) are a popular fuel cell for vehicles. The PEMFC generally includes a solid polymer electrolyte proton-conducting membrane, such as a perfluorosulfonic acid membrane. The anode and cathode typically include finely divided catalytic particles, usually platinum (Pt), supported on carbon particles and mixed with an ionomer. The catalytic mixture is deposited on opposing sides of the membrane. The combination of the anode catalytic mixture, the cathode catalytic mixture and the membrane define a membrane electrode assembly (MEA). MEAs are relatively expensive to manufacture and require certain conditions for effective operation.

Several fuel cells are typically combined in a fuel cell stack to generate the desired power. For example, a typical fuel cell stack for a vehicle may have two hundred or more stacked fuel cells. The fuel cell stack receives a cathode input reactant gas, typically a flow of air forced through the stack by a compressor. Not all of the oxygen is consumed by the stack and some of the air is output as a cathode exhaust gas that may include water as a stack by-product. The fuel cell stack also receives an anode hydrogen reactant gas that flows into the anode side of the stack. The stack also includes flow channels through which a cooling fluid flows.

The fuel cell stack includes a series of bipolar plates positioned between the several MEAs in the stack, where the bipolar plates and the MEAs are positioned between the two end plates. The bipolar plates include an anode side and a cathode side for adjacent fuel cells in the stack. Anode gas flow channels are provided on the anode side of the bipolar plates that allow the anode reactant gas to flow to the respective MEA. Cathode gas flow channels are provided on the cathode side of the bipolar plates that allow the cathode reactant gas to flow to the respective MEA. One end plate includes anode gas flow channels, and the other end plate includes cathode gas flow channels. The bipolar plates and end plates are made of a conductive material, such as stainless steel or a conductive composite. The end plates conduct the electricity generated by the fuel cells out of the stack. The bipolar plates also include flow channels through which a cooling fluid flows.

As is well understood in the art, fuel cell membranes operate with a controlled hydration level so that the ionic resistance across the membrane is low enough to effectively conduct protons. The relative humidity (RH) of the cathode outlet gas from the fuel cell stack is typically controlled to control the hydration level of the membranes by controlling several stack operating parameters, such as stack pressure, temperature, cathode stoichiometry and the relative humidity of the cathode air into the stack. By holding a particular set-point for cathode outlet relative humidity, for example 80%, the proper stack membrane hydration level can be maintained.

As mentioned above, water is generated as a by-product of the stack operation. Therefore, the cathode exhaust gas from the stack will include water vapor and liquid water. It is known in the art to recover water from the cathode exhaust stream and return it to the stack via the cathode inlet airflow. Many devices could be used to perform this function, such as a water vapor transfer (WVT) unit.

During fuel cell system shut-down, it is desirable that the membranes have a certain hydration level so they are not too wet nor too dry. This is typically accomplished by purging either the cathode side of the stack or both the cathode and anode side of the stack with dry air for a specific period of time. Too much water in the stack may cause problems for low temperature environments where freezing of the water could produce ice that blocks flow channels and affects the restart of the system. However, too long of a purge could cause the membranes to become too dry where the membranes will have too low of a protonic conductivity at the next system restart that affects restart performance as well as reduces the durability of the stack. The actual target amount of grams of water in the stack will vary depending on the system and certain system parameters.

For a fuel cell stack having three hundred fuel cells, and an active area near 400 cm² per cell, the stack may have about two hundred grams of water when the system is shut down. It is desirable that a stack of this size have about twenty-three grams of water during system shut-down so that the membranes are properly hydrated. Twenty-three grams of water is a stack λ of three, where λ represents the membrane hydration, that is the number of water molecules for each sulfonic acid molecule in the membrane of each fuel cell. By knowing how much water is actually in the fuel cell stack at system shut-down, a desirable air purge flow rate and air purge duration can be provided so that the target value of twenty-three grams of water can be achieved. Models can be employed to estimate the amount of water in the stack based on stack operating parameters during operation of the fuel cell system. However, there are many system operating parameters and as a result model accuracy is generally difficult to achieve during the course of vehicle operation from start-up to a subsequent shut-down, which may be up to several hours later.

It is known in the art to provide high frequency resistance (HFR) measurements of the membranes in a fuel cell stack to provide an accurate measurement of the water or membrane hydration in the fuel cell stack. HFR measurements provide a high frequency component on the electrical load of the stack which operates to create a high frequency ripple on the current output of the stack. The resistance of the high frequency component is measured, which is a function of the amount of water in the stack. Although HFR measurements give an accurate indication of the amount of water in the stack, the circuitry required to provide an HFR measurement is relatively costly, and not always reliable.

### SUMMARY OF THE INVENTION

In accordance with the teachings of the present invention, a system and method are disclosed for providing a fuel cell stack purge at fuel cell system shut-down. The method provides a two-stage purge process where the first stage purge uses humidified cathode air to get the fuel cell stack to a known stack hydration level from an unknown stack hydration level at system shut-down. As the stack is purged with the humidified air, the hydration level of the stack decreases asymptotically to the known stack hydration level that is in equilibrium with the RH of the air, where the duration of the first stage is set based on the asymptote as a safety margin. Once the known hydration level is achieved, then the second stage purge is performed with dry air to further reduce the stack hydration to a final desired hydration level.

Additional features of the present invention will become apparent from the following description and appended claims, taken in conjunction with the accompanying drawings.

### BRIEF DESCRIPTION OF THE DRAWINGS

FIG. 1 is a schematic block diagram of a fuel cell system; and

FIG. 2 is graph illustrating the grams of water in the stack on the y-axis and time on the x-axis.

### DETAILED DESCRIPTION OF THE EMBODIMENTS

The following discussion of the embodiments of the invention directed to a method for purging a fuel cell stack using a two-stage purging process is merely exemplary in nature, and is in no way intended to limit the invention or its applications or uses.

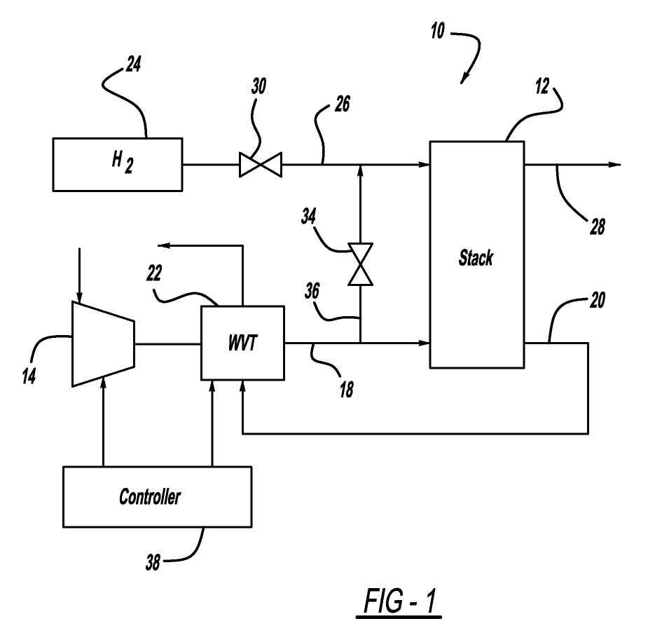

FIG. 1 is a schematic block diagram of a fuel cell system 10 including a fuel cell stack 12. The system 10 also includes a compressor 14 that provides a cathode inlet airflow on line 18 to the fuel cell stack 12. The cathode air exits the fuel cell stack 12 on a cathode exhaust line 20. A water vapor transfer (WVT) unit 22 is provided in the cathode input line 18. As is well understood to those skilled in the art, a WVT unit typically includes permeation membranes or other porous materials, and a by-pass line within. The moisture for the WVT unit 22 would typically be provided by the cathode exhaust gas from the cathode exhaust in the cathode exhaust line 20. A hydrogen source 24 provides fresh dry hydrogen to the anode side of the fuel cell stack 12 on anode input line 26, where an anode exhaust gas is output from the stack 12 on anode exhaust gas line 28. A valve 30, typically an injector, in the anode input line 26 regulates the flow of hydrogen into the fuel cell stack 12.

The fuel cell system 10 also includes a cathode inlet air by-pass line 36 that enables cathode air to be delivered to both the cathode and anode side of the fuel cell stack 12. During normal operation, a valve 34 in the cathode inlet air by-pass line 36 is closed to prevent air from mixing with hydrogen and entering the anode side of the fuel cell stack. During stack purging, the valve 34 in the cathode inlet air by-pass line 36 can be opened, and the valve 30 in the anode input line 26 closed, to purge water from the anode side of the stack 12.

According to the present invention, a purge of the fuel cell stack 12 is provided at system shut-down that removes enough water from the fuel cell stack 12 so that freeze conditions are not a problem, but ample membrane hydration is retained so that the membranes contain enough water for the next system start-up. The fuel cell system 10 does not need a high frequency resistance measurement to determine the water in the fuel cell stack 12 and does not need to know the amount of water in the fuel cell stack 12 at system shut-down. Instead the stack purge employs a two-stage purge process, where a first purge uses humidified cathode air from the compressor 14 to purge water from the fuel cell stack 12 until the hydration of the stack 12 is known via an asymptotic limitation, and then dry air from the compressor 12 is used in the second stage to reduce the stack hydration to the final hydration level.

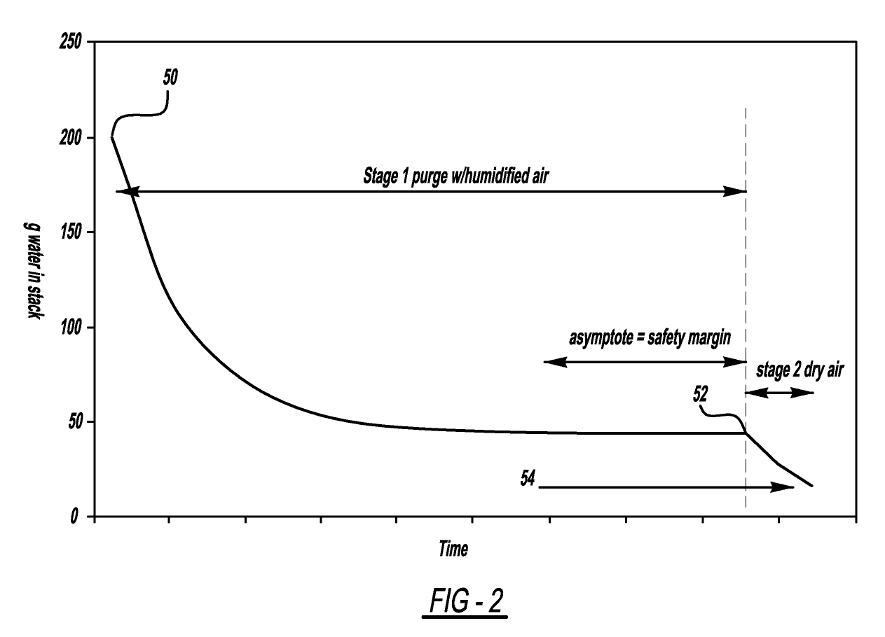

FIG. 2 is a graph with time on the horizontal axis and amount of water in the stack 12 on the vertical axis illustrating the two-stage purging process of the invention. The system 10 is shut down at point 50 where the amount of water in the stack 12 typically will be about 200 grams for a 300 cell stack having an active area of approximately 200 cm² per cell, but that amount of water will not be specifically known. During the first stage of the purge, air from the compressor 14 is used to purge the cathode side, and possibly both the cathode and the anode side, of the fuel cell stack 12 with air that is humidified by the WVT unit 22 at a known humidity level below 100%, for example, 80%. As is known in the art, the operation of the WVT unit 22 can be tightly controlled to control the humidification level of the cathode air being output therefrom.

During the first stage purge, the amount of water in the stack 12 will drop to some value, here about forty-eight grams of water in the stack 12, based on the amount of air humidification provided by the WVT unit 22. Because the inlet humidification of the cathode purge air is the same during the first stage purge, the amount of water in the stack 12 asymptotically reaches the particular amount of water for that humidification level after a certain amount of time. Therefore, even though the initial hydration level of the stack is not known accurately, because of the nature of the asymptote, a purge time can be specified that results in a known hydration level. After that time period has gone by, the WVT unit 22 can be by-passed and the purge air can be switched to dry air. Because the purge is dry, it will be known how long it will take the air to reduce the water in the stack 12 from the known amount of water at the end of the first stage to the desired amount of water, for example, twenty-three grams.

The length of the first stage purge can be set for how long the desired safety margin should be by assuming that the stack membrane at time 50 is completely hydrated. If a model is used to approximate the amount of water in the stack 12 based on system parameters at shut-down, then the length of the time of the first stage purge can be further reduced.

Utilizing this two-stage purge of the stack 12 removes water from the stack 12 in two ways. First, air can remove liquid water by physically blowing the water from the stack 12. This is an effective way to remove liquid water that has gathered in the channel and tunnel regions of the fuel cell stack 12, but is not an effective way to remove water that is present in the membrane or the water droplets present in the diffusion media. Thus, a second method is required to remove water from the membrane and the diffusion media by utilizing vapor-liquid equilibrium. This second method is the second stage of this invention, which involves feeding dry air into the stack 12. The water is thus removed as it humidifies the dry air. The equations describing water removal by the vapor-liquid equilibrium are:

y_{wsat}=f(T,P) (1)

Where y_{wsat} is the saturation mole fraction of water in air in gmole water/gmole total, and where:

$${N}_{w} = {F}_{air} [ ( \frac{{MW}_{w}}{{MW}_{air}} ) ( \frac{{y}_{wsat}}{1 - {y}_{wsat}} ) ] η \qquad ( 2 )$$

Where N_{w} is the water removal rate in g air/second, Fₐᵢᵣ is the dry air feed rate in g air/second, MW_{w} is the molecular weight of water, 18 g/gmole, MWₐᵢᵣ is the molecular weight of air, 28.8 g/gmole, y_{wsat} is the saturation mole fraction of water in air, gmole water/gmole total, and η is the effectiveness of water removal.

Equation (1) shows that the saturation mole fraction of water in air is a function of system temperature and pressure. For example, at 80° C. and 1.1 atm, y_{wsat} is 0.42 gmole water/gmole total. If the system temperature is reduced to 50° C., y_{wsat} becomes 0.11 gmole water/gmole total. Note that this relationship is a physical property, or thermodynamic property, of the water-air system.

Equation (2) shows how the rate of water removal increases with flow rate of dry air, saturation mole fraction of water, and the effectiveness of water removal. Because of the complexity of the system, the effectiveness of water removal is usually determined experimentally. As Fₐᵢᵣ increases, effectiveness will tend to decrease, approaching zero as Fₐᵢᵣ becomes infinite. Conversely, as Fₐᵢᵣ decreases, effectiveness increases, approaching unity as Fₐᵢᵣ approaches zero. Experience has shown that, for example, when drying a 300 cell stack with 380 cm² of active area per cell from 50 grams of water content down to 25 grams of water in 30 seconds results in a water removal effectiveness in the range of 0.95 to 1.0.

The foregoing discussion discloses and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. A fuel cell system comprising:
a fuel cell stack including a cathode side and an anode side;
a compressor providing cathode air to the cathode side of the fuel cell stack;
a water vapor transfer unit for humidifying the cathode air from the compressor before it is sent to the fuel cell stack; and
a controller controlling the compressor and the water vapor transfer unit during a fuel cell stack purge, said fuel cell stack purge including a first stage purge and a second stage purge, said compressor providing humidified cathode air through the water vapor transfer unit during the first stage purge to the fuel cell stack so that the stack hydration level drops to a known hydration value based on the relative humidity of the cathode inlet air during the first stage purge and then provides dry cathode air to the fuel cell stack during the second stage purge so that the stack hydration level drops from the known hydration value at the end of the first stage purge to a desired hydration level at the end of the second stage purge.

2. The system according to claim 1 wherein the controller includes a stack hydration model that estimates the amount of water in the fuel cell stack at system shut-down to determine the length of the first stage purge.

3. The system according to claim 1 wherein a length of the first stage purge is determined based on how long it will take the hydration level of the stack to asymptotically reach the known hydration value.

4. The system according to claim 1 wherein the known hydration value is about forty-eight grams of water in the stack.

5. The system according to claim 1 wherein the desired hydration level is about twenty-three grams of water in the stack.

6. The system according to claim 1 wherein the desired hydration level is three water molecules per each sulfonic acid molecule in membranes of fuel cells in the fuel cell stack.

7. The system according to claim 1 wherein the first stage purge includes using humidified cathode air that has a relative humidity level less than 100 percent.

8. The system according to claim 1 wherein the cathode air is used to purge either the cathode side or the anode side of the fuel cell stack or both.

9. The system according to claim 1 wherein purging the fuel cell stack during the first stage causes the hydration level of the fuel cell stack to drop to the known hydration value in an asymptotic manner.

10. A fuel cell system comprising:
a fuel cell stack including a cathode side and an anode side;
a compressor providing cathode air to the cathode side of the fuel cell stack;
a water vapor transfer unit for humidifying the cathode air from the compressor before it is sent to the fuel cell stack; and
a controller controlling the compressor and the water vapor transfer unit during a fuel cell stack purge, said controller including a stack hydration model that estimates the amount of water in the fuel cell stack at system shut-down, said fuel cell stack purge including a first stage purge and a second stage purge, said compressor providing humidified cathode air through the water vapor transfer unit during the first stage purge to the fuel cell stack so that the stack hydration level drops in an asymptotic manner to a known hydration value based on the relative humidity of the cathode inlet air during the first stage purge and then provides dry cathode air to the fuel cell stack during the second stage purge so that the stack hydration level drops from the known hydration value at the end of the first stage purge to a desired hydration at the end of the second stage purge, wherein the stack hydration model allows the controller to more accurately determine the length of the first stage purge.

11. The system according to claim 10 wherein the known hydration value is about forty-eight grams of water in the stack for a stack having approximately 300 cells and 400 cm² of active area per cell.

12. The system according to claim 10 wherein the desired hydration is about twenty-three grams of water in the stack for a stack having approximately 300 cells and 400 cm² of active area per cell.

13. The system according to claim 10 wherein the desired hydration level is approximately three water molecules per each sulfonic acid molecule in membranes of fuel cells in the fuel cell stack.

14. The system according to claim 10 wherein the first stage purge includes using humidified cathode air that has less than 100 percent relative humidity.

15. The system according to claim 10 wherein the cathode air is used to purge both the cathode side and the anode side of the fuel cell stack.

16. A method for purging a fuel cell stack in a fuel cell system, said method comprising:
purging the fuel cell stack with humidified air at a known relative humidity level; and
purging the fuel cell stack with dry air to bring the fuel cell stack to a desired hydration level.

17. The method according to claim 16 wherein purging the fuel cell stack with humidified air includes purging the fuel cell stack with humidified air so that the hydration level of the fuel cell stack asymptotically drops to the known hydration level.

18. The method according to claim 16 wherein the known hydration level is about 48 grams of water for a stack having approximately 300 cells and 400 cm² of active area per cell.

19. The method according to claim 16 wherein purging the fuel cell stack with dry air includes purging the fuel cell stack with dry air until the fuel cell stack reaches a desired hydration level of about 23 grams of water for a stack having approximately 300 cells and 400 cm² of active area per cell.

20. The method according to claim 16 further comprising using a stack hydration model for estimating the stack hydration level before purging the fuel cell stack with humidified air to determine how long to purge the fuel cell stack with humidified air.
